(19) United States
(12) Patent Application Publication
(10) Pub. No.: US 2019/0361505 A1
(43) Pub. Date: Nov. 28, 2019

(54) Apparatus for Modifying the Field of View of an Integrated Webcam for Enabling Hand Gesture Control of a Computer

(71) Applicant: Gergely Marton, Budapest (HU)

(72) Inventor: Gergely Marton, Budapest (HU)

(21) Appl. No.: 15/859,781

(22) Filed: Jan. 2, 2018

Related U.S. Application Data
(60) Provisional application No. 62/441,602, filed on Jan. 3, 2017.

(51) Int. Cl. G06F 1/16; G06F 3/03; G06F 3/01

(52) U.S. Cl. CPC G06F 1/1686; G06F 3/017; G06F 3/0325

(57) ABSTRACT

The invention comprises a computer accessory for providing the necessary sensor functionality for hand gesture controls of a computer equipped with a webcam integrated into the computer monitor, even while the user of a computer keeps his or her hands adjacent to the keyboard. This is achieved by modifying the field of view of the integrated webcam of a computer monitor so that the modified field of view will include the keyboard area of the computer. The field of view modification can be achieved with the utilization of lens, prism, mirror or optical waveguide. The invention, complemented with sufficient software, provides apparatus for enabling a user of a computer to control a computer with hand gestures comfortably, while the user barely moves his or her hands from the keyboard, and without the necessity of a further, not integrated webcam.

### CROSS-REFERENCE TO RELATED APPLICATIONS

This application claims the benefit of provisional patent application No. 62/441,602, filed Jan. 3, 2017, which is hereby incorporated by reference herein in its entirety.

### FIELD

The present invention relates, in general, to user interfaces for computerized systems, and in particular to user interfaces based on hand movements and gestures.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

A computer typically comprises a monitor (display screen) and an alphanumeric keyboard. Various cursor control devices can be integrated into or attached to the computer. An optical mouse uses a light source and a light detector in order to detect movement relative to a surface. The movement of the mouse can be translated into cursor movements by the computer. The easily portable version of a computer is a laptop. In a laptop, the screen can be folded onto the keyboard for convenient portability, and can be opened for use. A touchpad is usually integrated into a laptop, beside the keyboard. It also makes cursor control possible, while requires less space for operation than a mouse. The computer screen can be a touch sensor device itself, which allows accurate and intuitive interaction for the user. The operation of the above mentioned cursor control devices require that the user relocates his or her hand from the keyboard. During the use of a computer for work or for gaming, a user usually needs to switch between the keyboard and a pointing cursor control device (e.g. mouse) frequently or he or she needs to use such inputs simultaneously. Thus, cursor control devices that require less hand movement, i.e. can operate while the user holds his or her hands on, or slightly above the computer keyboard, are beneficial.

Some solutions reflect to this need. Mouse gloves, rings can be constructed using 3D accelerators and gyroscopes. A keyboard has been developed with integrated infrared sensors which enables gesture recognition above the area containing the keys (Microsoft Corporation, Redmond, Wash.). Motion sensing keyboards have been proposed, which utilize optical sensors integrated into the frame of the keyboards (U.S. application Ser. No. 12/334,320). For the implementation of these solutions, however, subtle and expensive additional electronic hardware components are needed.

A patent application describes a control system for computer cursor, which includes a video camera with an observation zone containing the keyboard (U.S. Ser. No. 08/863,870). Using such a system, the hand gestures of the user can be detected. Although most laptops are equipped with webcams, they have been developed to provide images of the face of their user, and cannot be configured to achieve such functionality. It would be desirable if the user of a computer could control a computer cursor without the need of relocating his or her hand from the computer keyboard and with a system that does not need additional high-cost hardware in addition to the already available elements of his or her computer.

### SUMMARY

The invention is an apparatus for providing the necessary sensor functionality for hand gesture controls of a computer, even while the user of a computer keeps his or her hands adjacent to the keyboard. This is achieved by modifying the field of view of the integrated webcam of a computer monitor so that the modified field of view will include the keyboard area of the computer when the computer is open for use. A webcam integrated into a monitor is typically directed so that its image contains the face of the user, and its field does not include the keyboard. The invention, complemented with sufficient software, provides apparatus for enabling a user of a computer to control the computer with hand gestures comfortably, while he or she barely moves his or her hands from the keyboard. The invention is compatible with computers equipped with monitors which have webcams integrated into their upper edge, and thus with most laptop computers. The invention modifies the field of view of the webcam with the utilization of at least one image-forming optical system, such as lens, prism, mirror or optical waveguide. The advantage of the invention compared to e.g. using a second webcam clipped onto the monitor and setting it up so that the second webcam monitors the keyboard, is that the implementation of this invention does not require additional sensors or electronic hardware, thus the implementation is cheaper and more compact.

### BRIEF DESCRIPTION OF DRAWINGS

FIGS. 1A and 1B show how the field of view of a webcam of a laptop is modified so that the modified field of view contains at least a portion of the keyboard area.

FIG. 2 illustrates the cross section of a cylindrical mirror positioned in a way that it can provide a field of view of a laptop webcam so that the modified field of view contains at least a portion of the keyboard area.

FIGS. 3A, 3B and 3C illustrate an embodiment comprising a cylindrical mirror with its attachment and positioning mechanisms.

FIGS. 4A and 4B show a second embodiment comprising a Fresnel prism combined with a lens.

FIG. 5 illustrates the attachment mechanism of the optical systems of the second embodiment.

### DESCRIPTION OF EMBODIMENTS

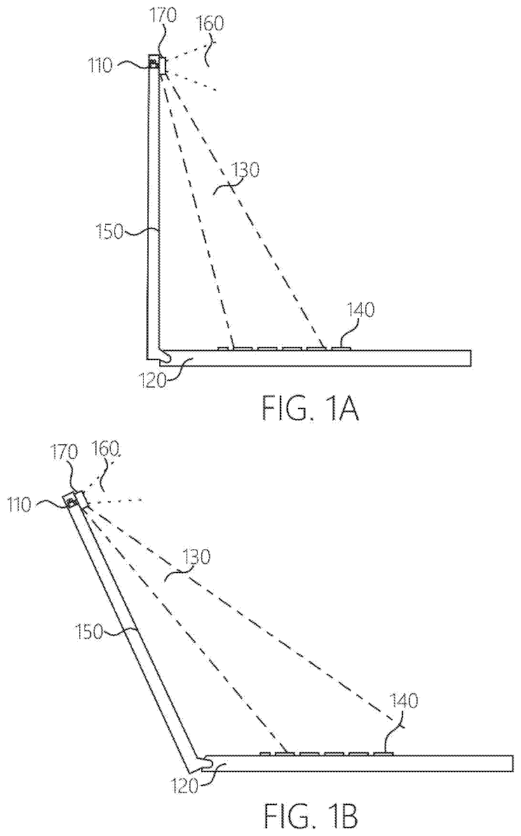

FIGS. 1A and 1B illustrate that the built-in webcam 110 of a laptop 120 can be provided with a modified vertical field of view 130 so that the modified vertical field of view 130 contains at least a portion of the keyboard 140 of the laptop 120. A laptop 120 is typically used with its screen 150 opened by an angle of minimum 90° and maximum 115°, relative to the plane of the keyboard 140. Its built-in webcam 110 is typically near the top edge of its screen 150. The original vertical field of view 160 of the webcam 110 is typically optimized to contain the face of a user. The present invention comprises a device 170 which is capable of providing a modified vertical field of view 130 for the webcam 110. If the modified vertical field of view 130 covers a 15°-30° angle range relative to the screen 150 of the laptop 110, a view on the region right above the rows of the alphabetic letter buttons of an English keyboard 140 can be provided. Therefore, the embodiments of the present invention detailed below were designed to cover this 15°-30° angle range regarding the vertical field of view. However, the invention is not limited to devices that can only provide this specific angle range. Regarding the image sharpness, the large depth of field of a typical built-in webcam 110 enables the image (e.g. the hand of the user above the keyboard) to be sharp at the desired distance range. Therefore, the present invention allows laptop users or other entities, such as software companies to write software which utilize the video output of a laptop webcam and utilizing the prevent invention, the video output will contain information about the hand position, hand shape and hand movements of the user of the laptop, while the laptop user keeps his/her hands on the laptop keyboard or slightly above the laptop keyboard.

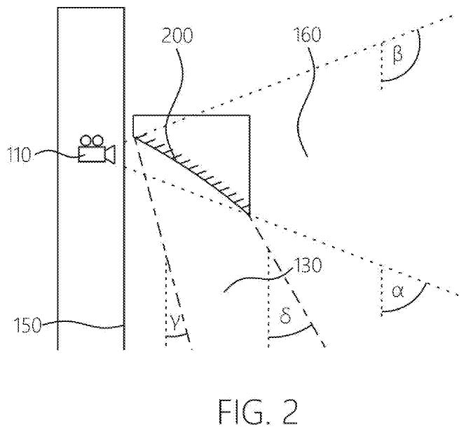

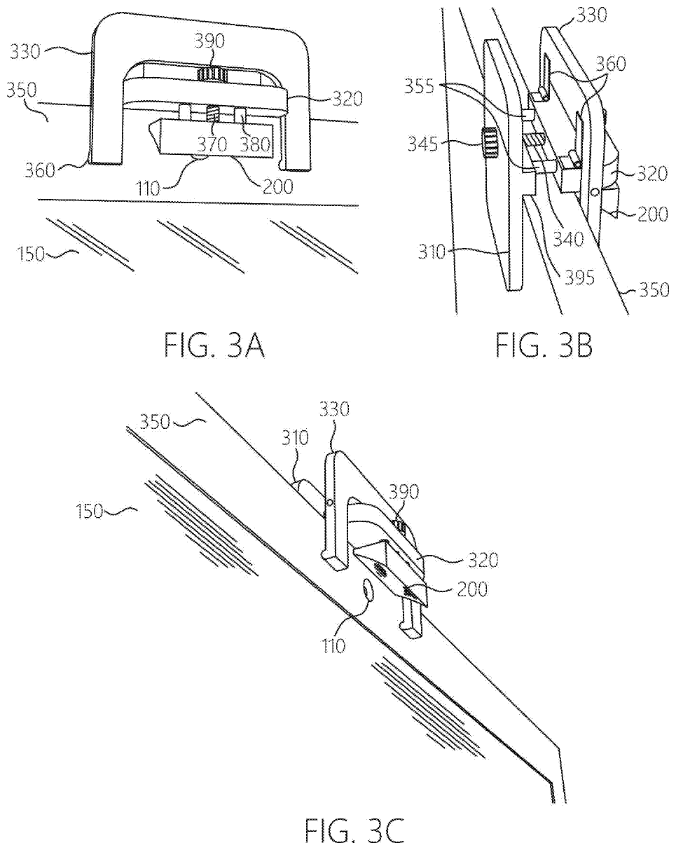

The first embodiment is illustrated in FIGS. 2 and 3. This embodiment utilizes a cylindrical, concave mirror 200 to block the original vertical field of view 160 of the webcam 110, which ranges from α=70° to β=110°. The mirror 200 provides a modified vertical field of view 130 ranging from γ=15° to δ=30°, in the vertical plane which is perpendicular to the laptop screen 150. Regarding the horizontal plane which is also perpendicular to the screen 150, the horizontal angle of view of the webcam 110 is sufficient to cover the alphabetic characters of the keyboard. The mirror is only curved when sectioned by a vertical plane, but straight when sectioned by a horizontal one, thus being cylindrical. FIG. 2 shows a horizontal section.

As shown in FIGS. 3A, 3B and 3C, the mirror is held in place and can be adjusted by a clip-like apparatus. The apparatus consists of a backside holder 310, a frontside holder 320 and a spring arm 330. The distance between the backside holder 310 and the frontside holder 320 can be adjusted by a horizontal screw 340, which can be rotated by a size setting wheel 345. This mechanism allows the mirror 200 to be compatible with laptops or standalone monitors of different screen frame 350 thickness. For accuracy, the backside holder 310 and frontside holder 320 are not solely attached to each other via the horizontal screw 340, as instead, they are supported by horizontal positioning rods 355. The spring arm 330 is attached to the frontside holder 320 rotatably, springs 360 ensure that the tips of the spring arm 330 press against the screen frame 350, and the tips of the spring arm 330 provide the necessary friction to keep the apparatus in place. The mirror 200 is attached to the frontside holder 320 through a vertical screw 370 and vertical positioning rods 380 in a similar manner like the backside holder 310 and the frontside holder 320 are attached to each other. The distance between the mirror 200 and the frontside holder 320 can be adjusted with a height setting wheel 390. This mechanism allows the mirror 200 to be compatible with various webcam 110 positions. The clip-like apparatus enables the user to easily put on and remove the mirror 200. A positioning ledge 395 on the backside holder 310 enables the user to easily put the mirror 200 into correct position once it has been adjusted by the size setting wheel 345 and the height setting wheel 390.

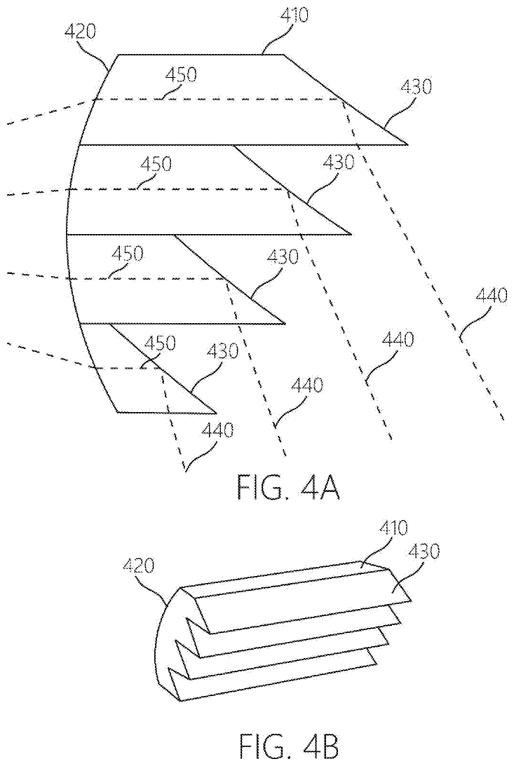

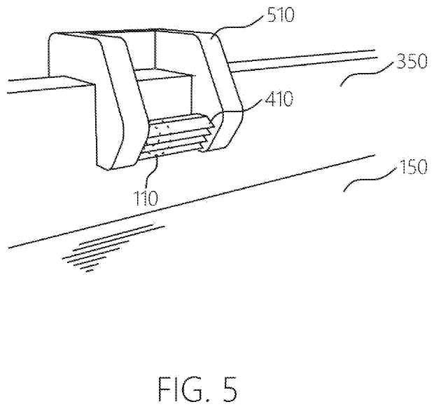

The second embodiment, shown in FIGS. 4A, 4B and 5 contains a Fresnel prism 410 equipped with a lens surface 420. Fresnel optical systems allow the deflection of light rays with the utilization of more compact geometries than common lenses, mirrors and prisms. The drawback of Fresnel optical systems is that the discontinuities cause distortion in the images, which is not a big disadvantage if the images are used in a motion detection application. FIG. 4A shows the light ray distraction behavior of the system made of a transparent material with refractive index of approximately 1.5 times the surrounding medium. The angled upper faces 430 of the Fresnel prism 410, which cause total internal reflection, are slightly curved, concave from the viewpoint of the prism 410. This allows the incoming rays 440 ranging from 15-30 degrees (with respect to the vertical plane) to be transformed into parallelized rays 450. The surface of the prism 410 on its back is a convex lens 420, which can collect the rays into the aperture of webcam 110 of the laptop 120. From the two-dimensional shape illustrated in FIG. 4A, the prism 410 is extruded parallel to the plane of the paper, into its three-dimensional prismatic shape shown in in FIG. 4B. This embodiment utilizes a custom-made holder 510, shown in FIG. 5, which is only compatible with a specific laptop type or standalone computer monitor type. The Fresnel prism 410 is incased into the custom-made holder 510. The custom-made holder 510 matches the geometry of the screen frame 350, thus it can be attached onto the screen frame 350 in a correct position, intuitively. By doing so, the Fresnel prism 410 is installed into a position where it provides a modified vertical field of view 130 for the webcam 110, which contains at least a portion of the keyboard 140 area.

### CITATION LIST

US 20130094126 A1 (Benjamin M. Rappoport et al.) Apr. 18, 2013.
U.S. Pat. No. 7,911,457 B2 (Micha Vardi) Mar. 22, 2011.
U.S. Pat. No. 6,128,003 A (Anthony Vernon Walker Smith et al.) Oct. 3, 2000.
US 20070253703 A1 (Wen-Ji Tsai et al.) Nov. 1, 2007.
U.S. Pat. No. 5,801,919 A (Richard W. Griencewic) Sep. 1, 1998.
U.S. Pat. No. 7,466,542 B2 (Yan-Lin Kuo et al.) Dec. 16, 2008.
U.S. Pat. No. 7,917,935 B2 (Paul McAlpine et al.) Mar. 29, 2011.
U.S. Pat. No. 8,432,485 B1 (Mark Martinez et al.) Apr. 30, 2013.
U.S. Pat. No. 5,736,976 A (Nina T. Cheung) Apr. 7, 1998.
U.S. Pat. No. 5,821,922 A (Charles A. Sellers) Oct. 13, 1998.
US 20100149099 A1 (John Greer Elias) Dec. 12, 2008.

1. An accessory for a computer, the computer comprising a keyboard and a monitor, the monitor comprising a screen and an integrated webcam, the accessory comprising:
attachment means for being attached to the monitor,
means for providing a modified field of view for the webcam of the monitor so that the modified field of view of the webcam of the monitor contains an area relative to the monitor, in which area the keyboard of the computer is commonly located.

2. The accessory of claim 1, wherein the accessory comprises an optical system and said attachment means comprises a drive mechanisms, which drive mechanism provides movement for the optical system in a direction perpendicular to the screen.

3. The accessory of claim 1, wherein the accessory comprises an optical system and said attachment means comprises a drive mechanisms, which drive mechanism provides movement for the optical system in a direction parallel to the screen.

4. The accessory of claim 1, wherein the accessory comprises a light mirroring surface.

5. The accessory of claim 1, wherein the accessory comprises more than one light mirroring surfaces and at least some of the light mirroring surfaces form a Fresnel-mirror.

6. The accessory of claim 1, wherein the accessory comprises a lens.

7. The accessory of claim 1, wherein the accessory comprises a Fresnel-lens.

8. The accessory of claim 1, wherein the accessory comprises a waveguide.

9. The accessory of claim 1, wherein the accessory comprises an optical system, which optical system comprises a glass component.

10. The accessory of claim 1, wherein the accessory comprises an optical system, which optical system comprises a plastic component.

11. An accessory for a laptop computer, the laptop computer having at least one open state, screen, keyboard and integrated webcam, the accessory comprising means for being attached to the laptop,
means for providing a modified field of view for the webcam of the laptop so that provided that the laptop is in at least one of its open states, the modified field of view of the webcam of the laptop contains at least a part of the keyboard of the laptop.

12. The accessory of claim 11, wherein the accessory comprises an optical system and said attachment means comprises a drive mechanisms, which drive mechanism provides movement for the optical system in a direction perpendicular to the screen.

13. The accessory of claim 11, wherein the accessory comprises an optical system and said attachment means comprises a drive mechanisms, which drive mechanism provides movement for the optical system in a direction parallel to the screen.

14. The accessory of claim 11, wherein the accessory comprises a light mirroring surface.

15. The accessory of claim 11, wherein the accessory comprises more than one light mirroring surfaces and at least some of the light mirroring surfaces form a Fresnel-mirror.

16. The accessory of claim 11, wherein the accessory comprises a lens.

17. The accessory of claim 11, wherein the accessory comprises a Fresnel-lens.

18. The accessory of claim 11, wherein the accessory comprises a waveguide.

19. The accessory of claim 11, wherein the accessory comprises an optical system, which optical system comprises a glass component.

20. The accessory of claim 11, wherein the accessory comprises an optical system, which optical system comprises a plastic component.
